(19) United States
(12) Patent Application Publication
(10) Pub. No.: US 2012/0133768 A1
(43) Pub. Date: May 31, 2012

(54) Rear Vision Video Camera and Display Screen System for a Vehicle

(76) Inventor: Said Youssef Stephan, Bossley Park (AU)

(21) Appl. No.: 13/388,658

(22) PCT Filed: May 27, 2010
(86) PCT No.: PCT/AU2010/000648

§ 371 Date: Feb. 2, 2012

(30) Foreign Application Priority Data
Aug. 6, 2009 (AU) 2009903669

(51) Int. Cl. H04N 7/18

(52) U.S. Cl. 348/148; 348/E07.085

(57) ABSTRACT

A rear vision video camera and display screen system for a motor vehicle (10) has externally mounted left and right side view video cameras (24, 26) for viewing regions to the side of the vehicle, and a rear view video camera (22) mounted at the rear of the vehicle for viewing a region behind the vehicle. The system also includes a monitor display screen (12) located on a dashboard of the vehicle for viewing by a driver of the vehicle. The display screen (12) receives and displays views of each of the regions taken by the video cameras. The rear view video camera (22) is controlled by a swivel mechanism which moves the camera to a first position when the driver shifts into reverse gear. The first position allows the camera (22) to observe the region immediately behind the vehicle. The swivel mechanism also moves the camera (22) to a second position when the driver engages a gear for forward motion, whereby a wider field of view is observable at the rear of the vehicle.

### FIELD OF THE INVENTION

The present invention relates to a rear vision video camera and display screen system for a vehicle and, in particular, for a motor vehicle.

Although the background, objects and preferred embodiments of the invention will be hereinafter described with reference to a rear vision video camera and display screen system for a motor vehicle, such as a car, van, bus, truck, tractor, excavator and other motor driven machinery, it is to be understood that the invention is not limited thereto but has wider application. For example, the rear vision video camera and display screen system may be used for a vehicle towed behind a motor vehicle, such as a trailer, caravan and mobile plant used in road works, mines and construction sites.

It is to be understood that the terminology employed herein is for the purpose of description only and should not be regarded as limiting. For instance, the terms “comprising” or “comprises” are to be understood as meaning “including”, unless otherwise stated. Also, the term “rear vision” is to be understood as meaning a view rearwardly from the left and right sides of the vehicle (i.e. a side view), as well as a view rearwardly from behind the vehicle (i.e. a rear view).

### BACKGROUND OF THE INVENTION

Motor vehicles commonly have an internal rear view mirror and external side view mirrors upon which a driver relies for viewing the regions to the rear and sides of the vehicle while driving, and particularly when reversing, changing lanes or merging into traffic.

Not all drivers correctly utilize rear vision mirrors, and even when they are correctly utilized, they do not always allow for full viewing of the desired region. This is especially so at “blind spots” around the vehicle. It is a common practice to turn the head around to look to the side or rear in order to compensate for the “blind spots”. This is not always a safe option as a collision may occur with a vehicle ahead of the driver if, whilst the driver's head is turned, the vehicle ahead were to stop abruptly or the driver were to veer from his lane.

An internal rear view mirror provides limited visibility when a driver is reverse parking. The driver may not correctly estimate the distance between his vehicle and the parked vehicle behind him, even if the driver turns his head rearwardly for a better view.

Also, the external side view mirrors can sometimes have their correct positions disturbed by inadvertent or deliberate contact. Similarly, an internal rear view mirror may not always be correctly positioned and require adjustment depending on the size or seating posture, and hence the eye position, of the driver.

External side view mirrors are also prone to being covered by moisture arising from a range of weather conditions, and their location on the outside of a vehicle interferes with the vehicle's aerodynamic characteristics and creates drag that reduces fuel efficiency.

In view of the aforementioned problems and shortcomings with rear vision mirrors, alternative means for providing a driver with views rearwardly of a motor vehicle have been sought.

There have been various attempts by others to provide rear vision video camera and display screen systems for motor vehicles, but these have resulted in very complex, expensive and damage prone arrangements that are not suited to the wider market of smaller, inexpensive and fuel efficient motor vehicles. Nor do such prior art systems have the range of features most desired by safety conscious drivers and younger drivers at this time when driving disqualification is high on the mind of such drivers.

### SUMMARY OF THE INVENTION

It is an object of the present invention to overcome or substantially ameliorate at least some of the disadvantages and problems of the aforementioned prior art, or at least provide a useful alternative.

It has been found by the present inventor that these and other objects of the invention may be achieved in general by providing a rear vision video camera and display screen system for a motor vehicle comprising externally mounted left and right side view video cameras for viewing regions to the side of the vehicle, and a rear view video camera mounted at the rear of the vehicle for viewing a region behind the vehicle, a display screen located on a dashboard of the vehicle for viewing by a driver of the vehicle, the monitor display screen receiving and displaying views of each of the regions taken by the video cameras, wherein the rear view video camera is controlled by a swivel mechanism which moves the camera to a first position when the driver shifts into reverse gear, wherein the first position allows the camera to observe the region immediately behind the vehicle, the swivel mechanism also moving the camera to a second position when the driver engages a gear for forward motion, whereby a wider field of view is observable at the rear of the vehicle.

Preferably, the view taken by the rear view video camera is displayed on a section at the centre of the monitor display screen via a video cable.

In a preferred form, the monitor display screen is further divided into other sections so that the right side view video camera displays its view on a section at the top right, and the left side view video camera displays its view on a section at the top left of the screen.

It is preferred that a top middle section of the screen is reserved for an integrated GPS system, and a bottom section of the screen is utilized to display all other dashboard indications.

Also, the screen is preferably adjustable by a tilt and vertical shift mechanism.

In a further preferred form, each of the video cameras is contained in an aerodynamically flared housing that is weather proof and integral with the shell of the vehicle.

Preferably, an opening of the housing through which the camera peers is sealed by a clear cover that prevents ingress of water and protects the camera against impact damage from rocks and other debris.

In a still further preferred form, water jet nozzles are mounted on the shell of the vehicle adjacent to each of the side view video cameras and rear view video camera for spraying a jet of water to clean mud, dust, dirt, condensation and the like away from the view of the camera.

There has been thus outlined, rather broadly, the more important features of the invention in order that the detailed description thereof that follows may be better understood and put into practical effect, and in order that the present contribution to the art may be better appreciated.

There are additional features of the invention that will be described hereinafter. As such, those skilled in the art will appreciate that the conception, upon which the disclosure is based, may be readily utilized as the basis for designing other assemblies and processes for carrying out the objects of the present invention. It is important, therefore, that the broad outline of the invention described above be regarded as including such equivalent constructions in so far as they do not depart from the spirit and scope of the present invention.

### SUMMARY OF THE DRAWINGS

In order that the present invention may be readily understood and put into practical effect, reference will now be made to the accompanying drawings, in which:

FIG. 1 is a top view of a motor vehicle provided with a rear vision video camera and display screen system according to a preferred embodiment of the present invention, with a portion of the shell of the vehicle cut away to show a dashboard mounted monitor display screen and other system control components,

FIG. 2 is a side view of the motor vehicle as shown in FIG. 1,

FIG. 3 is a front view of the motor vehicle as shown in FIG. 1,

FIG. 4 is a rear view of the motor vehicle as shown in FIG. 1,

FIG. 5 is an enlarged view of a cut away portion of the shell of the motor vehicle of FIG. 1 showing a flared housing containing a video camera alongside a water jet nozzle,

FIG. 6 is a schematic block diagram of a rear vision video camera and display screen system according to a preferred embodiment of the present invention, and

FIG. 7 is a simplified circuit diagram of the operating electronics for a reverse gear shifter controlled two-position swivel mechanism for a rear view video camera of the system of FIGS. 1 to 6.

### DETAILED DESCRIPTION OF PREFERRED EMBODIMENT

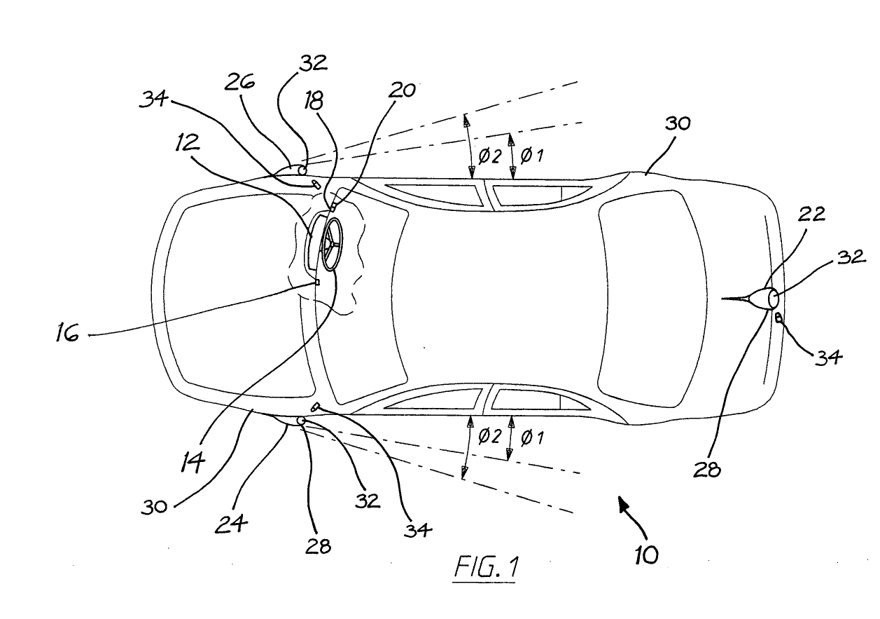

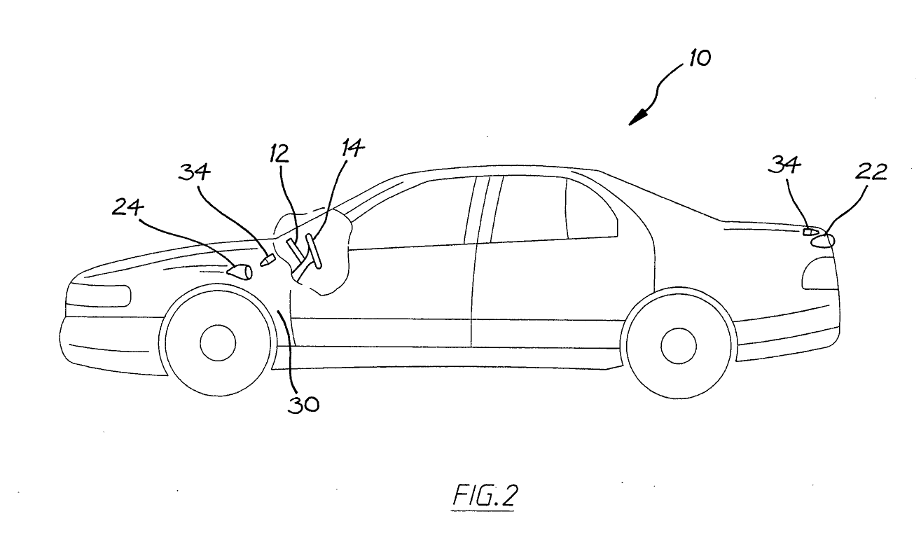

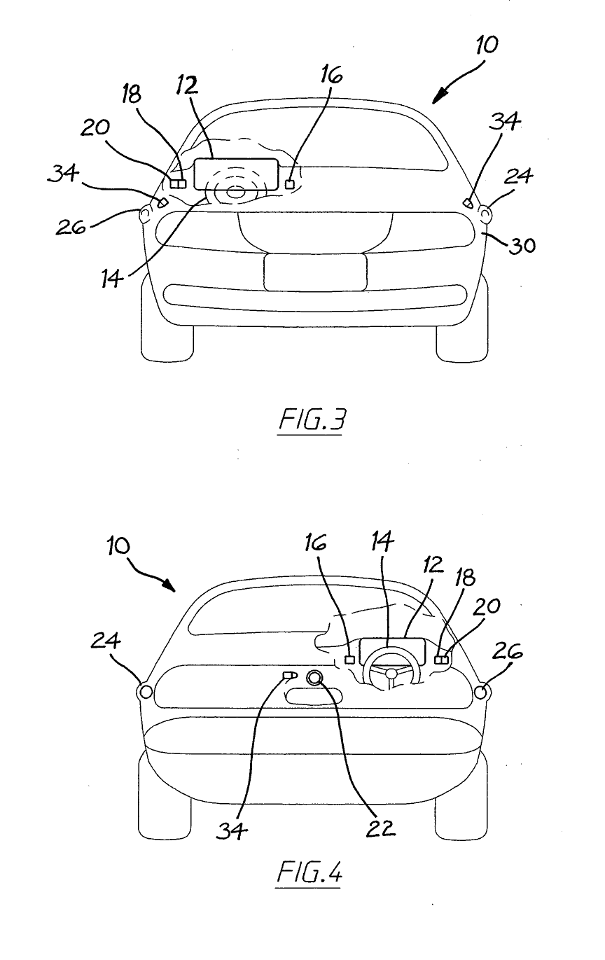

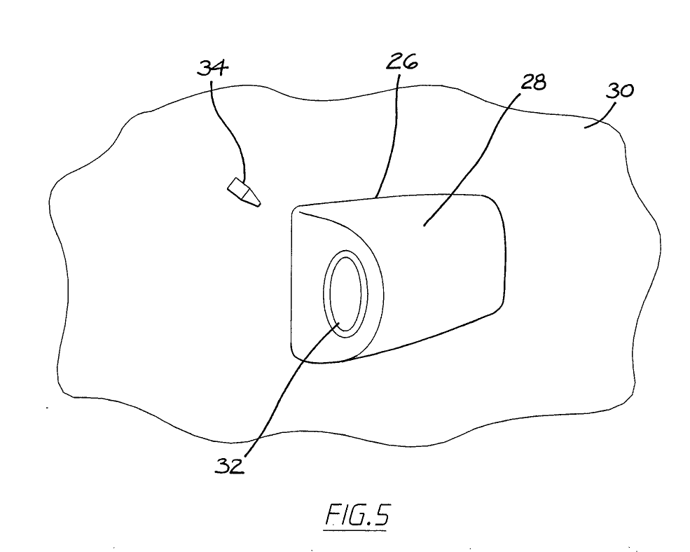

The motor vehicle 10 shown in FIGS. 1 to 4 is a typical sedan but does not have any internally mounted rear view mirror or externally mounted side mirrors. The vehicle is shown with portions cut away to show various dashboard mounted components of the rear vision video camera and display screen system.

There is a monitor display screen 12 integrally constructed and cooperating with the dashboard behind the steering wheel 14. Mounted alongside the screen 12 are a water jet push button 16, a selector switch 18, and swivel and zoom toggles 20, the structure and function of each of which will be described later in the specification.

The system also includes three externally mounted video cameras, namely, a rear view video camera 22, a left side view video camera 24, and a right side view video camera 26, which can each communicate with the monitor display screen 12.

The cameras 22, 24, 26 are miniature star-light video cameras of a suitable megapixels size. The side video cameras 24, 26 are mounted on the most protruding part of each of the sides of the vehicle, and as close to the front and as high from the ground as possible, for unobstructed rearward views.

The rear video camera 22 is mounted as centrally as possible on the rear end of the vehicle so as to view an optimal region behind the vehicle.

Each of the video cameras 22, 24, 26 is contained in an aerodynamically flared housing 28 that is weather proof and integral with the shell 30 of the vehicle. The opening of the housing 28 through which the camera lens peers is sealed by a clear cover 32 that prevents ingress of water and protects the camera against impact damage from rocks and other debris. Splash guards may also be used.

Water jet nozzles 34 are mounted on the shell 30 of the vehicle adjacent to each of the side video cameras 24, 26 and rear video camera 22 for spraying a jet of water to clean mud, dust, dirt, condensation and the like away from the cover 32 of the camera housing 28 or, where the cover is absent, from the lens of the camera.

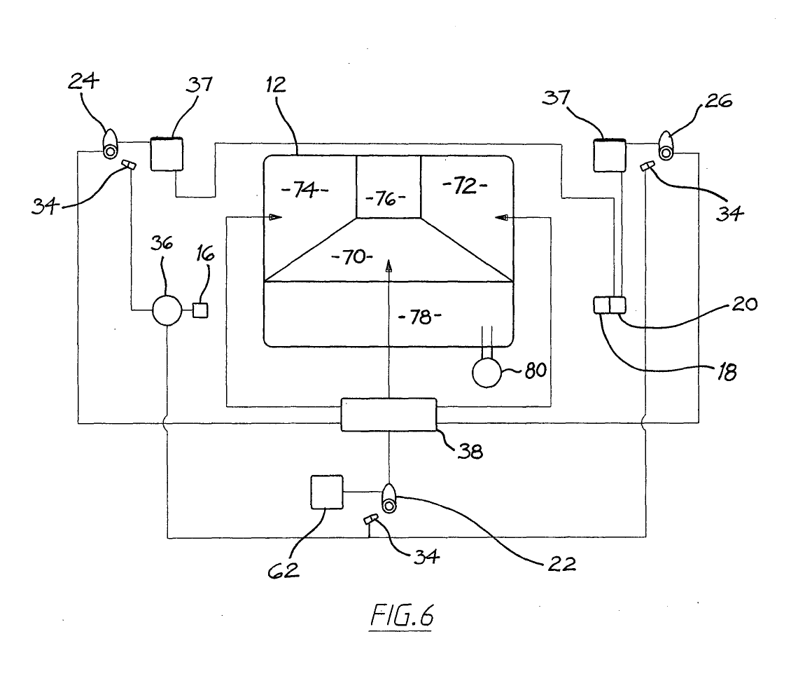

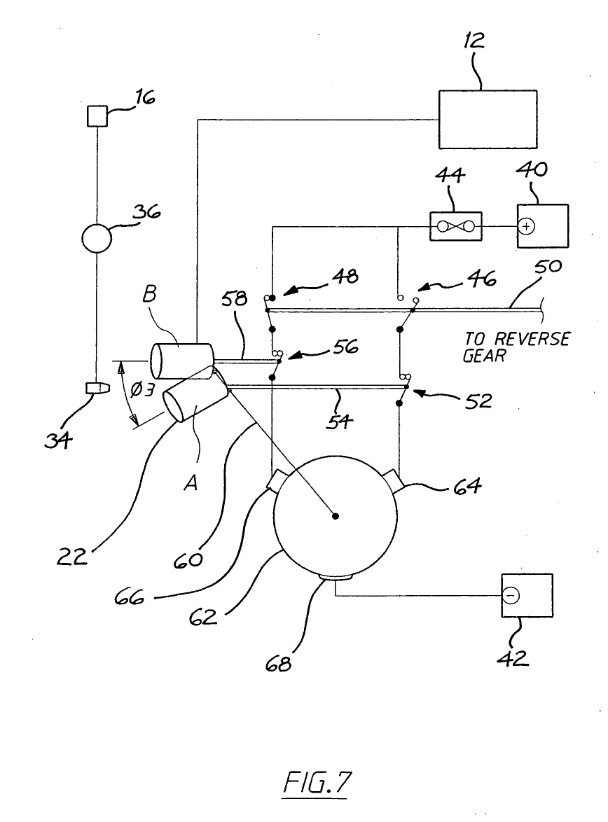

The water jet push button 16 controls a motor 36 (shown in FIGS. 6 and 7) that operates a selected water jet nozzle 34 to spray a jet of water for the intended purpose.

The selector switch 18 is used to select which one of the two side video cameras 24, 26 is to be swivelled and have its views enlarged by a zoom mechanism.

The swivel and zoom toggles 20 control a suitable swivel or zoom motor or mechanism 37 for a selected side video camera 24, 26.

The rear video camera 22 can be swivelled and have its view enlarged by a zoom mechanism through the operation of a reverse gear shifter controlled two-position swivel mechanism which will be described in detail later in the specification.

The video outputs of cameras 22, 24, 26 are communicated to the monitor display screen 12 either through suitable video cables or by wireless means. These outputs are amplified and interfaced via a suitable electronic facility 38 (as shown in FIG. 6) that also ensures that the video displayed on the screen 12 is not a reversed image.

As shown in FIG. 1, each side video camera 24, 26 has a normal viewing angle (φ1) that is set to observe an adjacent traffic lane over a field of view covering the entire length of a vehicle so as to eliminate the “blind spots” of prior art side mirrors. The swivel and zoom toggles 20 for the side video cameras 24, 26 allow the swivel and zoom mechanisms to enlarge this field of view into a larger viewing angle (φ2) whereby additional traffic lanes and other peripheral objects may be observed.

A reverse gear shifter controlled two-position swivel mechanism for the rear video camera 22 is shown in terms of the simplified circuit diagram of FIG. 7. The swivel mechanism can move the camera 22 to position A when the driver shifts into reverse gear. Position A allows the camera 22 to observe the region immediately behind the vehicle. The swivel mechanism can also move the camera 22 to position B (through an angle φ3) when the driver engages a gear for forward motion, whereby a wider field of view is observable at the rear of the vehicle.

The circuit for the reverse gear shifter controlled two-position swivel mechanism is powered from the vehicle's battery represented by the positive terminal 40 and the negative terminal 42. In the vehicle's fuse panel is a protective fuse 44 of a suitable rating that is connected with the positive terminal 40. Connected in parallel from the fuse 44 are microswitches 46, 48. Microswitch 46 is normally open and is operated by a lever 50 linked to the reverse gear and operable to close when the reverse gear is engaged. The microswitch 46 has a delay of, say, 0.25 seconds to prevent operation as the gear lever is shifted between gears. Microswitch 48 is normally closed and is operated by the same lever 50 linked to the reverse gear. The microswitch 48 opens as soon as the reverse gear is engaged.

Another microswitch 52 is in series with microswitch 46 and is normally closed. Microswitch 52 opens by operation of first cog 54 as soon as the rear camera 22 is swung downward to position A.

Yet another microswitch 56 is in series with microswitch 48 and is normally closed. Microswitch 56 opens by operation of second cog 58 when the camera is in normal viewing position B or is swung back to this position by a coupling arm 60 between the camera 22 and a motor 62 for changing the position of the camera 22 between positions A and B. The normal viewing position of rear camera 22 is assumed when driving forward and is parallel to the driving surface.

The motor 62 has a forward motion terminal 64 which, when activated, causes the rear camera 22 to swing downwardly for, say, a better view during reverse parking. Such a view may be gained when the rear video camera 22 has swung to an angle of, say, 70 degrees to the horizontal or whatever angle (φ3) is most suited to its mounting location. There is also a reverse motion terminal 66 of the motor 62 which, when activated, causes the camera 22 to swing back upwardly to its normal viewing position B. A common terminal 68 of the motor 62 is connected with the negative terminal 42.

Views from the rear video camera 22 may be enlarged by a zoom mechanism that may be activated in a variety of ways. Enlargement of the rear view may be triggered by shifting into reverse gear, or by proximity of the camera 22 to a rearward object, or by the driver touching the screen, or by a separate manual control.

The video output of rear camera 22 is ultimately displayed on a section 70 at the centre of the dashboard mounted monitor display screen 12 via, in this instance, a video cable.

The monitor display screen 12 is also divided into other sections. The right (driver's) side view video camera 26 displays its output on a section 72 at the top right, and the left (passenger's) side view video camera 24 displays its output on a section 74 at the top left of the screen 12.

The top middle section 76 of the screen 12 can be reserved for an integrated GPS system, and bottom section 78 of the screen 12 can be utilized to display all other dashboard indications.

The monitor display screen 12 is so located that it can be viewed at a glance by the driver, and the displayed outputs of the side cameras 24, 26 blend with the view seen through the front wind shield. A tilt and vertical shift mechanism 80 is provided for the screen 12 to optimize viewing and blending. For further ease of viewing, the screen 12 has anti-glare properties and may have dimmer control. The screen 12 is connected to the vehicle's on-board computer.

As an alternative to an integral construction with the dashboard, the monitor display screen may be installed as an “add on” kit (or retrofitted) to the dashboard.

The video cameras may be configured to cooperate with proximity sensors that can audibly alarm the driver to the danger of a collision, say, when reverse parking or changing lanes.

It will be apparent to persons skilled in the art that the rear vision video camera and display screen system for a motor vehicle may be made of many suitable materials.

It will also be readily apparent from the above that there are various advantages of the present invention.

Furthermore, it will be readily apparent to persons skilled in the art that various modifications may be made in details of design and construction of the embodiments of the rear vision video camera and display screen system for a motor vehicle, and in the steps of using the system described above, without departing from the scope or ambit of the present invention.

1. A rear vision video camera and display screen system for a motor vehicle comprising externally mounted left and right side view video cameras for viewing regions to the side of the vehicle, and a rear view video camera mounted at the rear of the vehicle for viewing a region behind the vehicle, a monitor display screen located on a dashboard of the vehicle for viewing by a driver of the vehicle, the display screen receiving and displaying views of each of the regions taken by the video cameras, wherein the rear view video camera is controlled by a swivel mechanism which moves the camera to a first position when the driver shifts into reverse gear, wherein the first position allows the camera to observe the region immediately behind the vehicle, the swivel mechanism also moving the camera to a second position when the driver engages a gear for forward motion, whereby a wider field of view is observable at the rear of the vehicle.

2. The system of claim 1 wherein the view taken by the rear view video camera is displayed on a section at the centre of the monitor display screen via a video cable.

3. The system of claim 2 wherein the monitor display screen is further divided into other sections so that the right side view video camera displays its view on a section at the top right, and the left side view video camera displays its view on a section at the top left of the screen.

4. The system of claim 3 wherein a top middle section of the screen is reserved for an integrated GPS system, and a bottom section of the screen is utilized to display all other dashboard indications.

5. The system of claim 1 wherein the screen is adjustable by a tilt and vertical shift mechanism.

6. The system of claim 1 wherein each of the video cameras is contained, in an aerodynamically flared housing that is weather proof and integral with the shell of the vehicle.

7. The system of claim 6 wherein an opening of the housing through which the camera peers is sealed by a clear cover that prevents ingress of water and protects the camera against impact damage from rocks and other debris.

8. The system of claim 1 wherein water jet nozzles are mounted on the shell of the vehicle adjacent to each of the side view video cameras and rear view video camera for spraying a jet of water to clean mud, dust, dirt, condensation and the like away from the view of the camera.

9. The system of claim 8 wherein a water jet push button mounted on the dashboard is used to control a motor that operates a selected water jet nozzle to spray the jet of water.

10. The system of claim 9 wherein the left and right side view video cameras each have a normal viewing angle that is set to observe an adjacent traffic lane over a field of view covering the entire length of a vehicle, and have a larger viewing angle whereby additional traffic lanes and other peripheral objects may be observed, and wherein a selector switch mounted on the dashboard is used to select which one of the two side view video cameras is to have its viewing angle adjusted.
